(19) United States
(12) Patent Application Publication
(10) Pub. No.: US 2023/0150299 A1
(43) Pub. Date: May 18, 2023

(54) SUPPORT CLIP-BRUSH HOLDER AND BRUSH KEEPER ASSEMBLY FOR STORING PAINT BRUSHES

(71) Applicant: John Allen Richardson, Toledo, OH (US)

(72) Inventors: John Allen Richardson, Toledo, OH (US); Raymond Michael Niscior, Toledo, OH (US)

(73) Assignee: John Allen Richardson, Toledo, OH (US)

(21) Appl. No.: 17/845,671

(22) Filed: Jun. 21, 2022

Related U.S. Application Data
(63) Continuation-in-part of application No. 17/528,083, filed on Nov. 16, 2021.

(51) Int. Cl. B44D 3/12

(52) U.S. Cl. CPC B44D 3/123

(57) ABSTRACT

A support clip includes a container engagement section for mounting the support clip to an upper interior portion of a paint container, and a brush holder support section. A brush holder carries a vertically suspended paint brush. Edge surfaces of the container engagement section include a first segment, a second segment, and an intermediate segment, which engage inner and lower surfaces of the container rim and an inner sidewall surface. A brush keeper kit for a paint brush employs used paint containers as brush keeper parts. The brush keeper kit includes a paint container adapter and a brush holder. The paint container adapter has an outer rim and an inner ledge, which define upper and lower sections for coupling upper and lower paint containers. The brush holder is mounted to an upper interior portion of the lower paint container and supports the paint brush within an interior space.

### CROSS REFERENCE TO RELATED APPLICATIONS

This application is a continuation-in-part of U.S. patent application Ser. No. 17/528,083, filed on Nov. 16, 2021, entitled “SUPPORT CLIP-BRUSH HOLDER AND BRUSH KEEPER ASSEMBLY FOR STORING PAINT BRUSHES,” which is incorporated herein by this reference.

### TECHNICAL FIELD

The present disclosure relates generally to support clips, brush holders and brush keepers for storing paint brushes between uses.

### BACKGROUND

One of the most common challenges faced by individuals who use a paint brush to apply paint from a paint container, such as a paint can or a paint bucket, is placement of the paint brush at rest during periods when painting is interrupted. Typically, the individual will place the paint brush in or on the container, either oriented vertically with the bristles of the brush resting against the bottom of the container, or oriented horizontally with the bristles resting against the top of the container. It is known to employ paint brush holders for this purpose, but generally such brush holders require that the holder, the brush, or both extend to the exterior of the container.

It is also known to use brush keepers to cover paint brushes for wet storage of the paint brushes when not in use. Typically, brush keepers are specialized devices that require transferring the paint brush to the brush keeper rather than storing the brush in its normal work environment.

### SUMMARY

What is needed are improved method and apparatus for holding and storing paint brushes during periods when painting is interrupted. What is needed are simplified, time-saving methods for storing paint brushes during periods between uses. What is needed are methods and apparatus for holding paint brushes that use interior space within paint containers for compact, space-saving storage. What is needed are environmentally friendly methods for storing paint brushes that make use of materials on hand.

In an embodiment of a support clip, a flat member includes a container engagement section having a plurality of edge surfaces configured to mount to an upper interior portion of a paint container, and further includes a brush holder support section. The brush holder support section of the support clip is configured to carry a brush holder within the interior of the paint container. The edge surfaces of the container engagement section include a first segment and a second segment. The first segment is configured to engage an inner sidewall surface of the paint container extending below the rim. The second segment is configured to engage an inner edge of an annular rim, which extends inwardly from the upper edge of the sidewall of the paint container. The container engagement section may further include an intermediate segment extending between the first segment and the second segment, wherein the intermediate segment is configured to engage a lower surface of the rim.

In another embodiment, a support clip includes a flat member including a container engagement section comprising a plurality of edge surfaces, a brush holder support section configured for mounting a paint brush holder to the support clip and for supporting the paint brush holder, and a leg extending from the flat member adjacent the brush holder support section. The support clip defines a gap between the leg and the brush holder support section. The support clip includes two orientations that may be employed with different types of paint container.

In a first orientation of the support clip, the support clip is configured such that the plurality of edge surfaces of the container engagement section include a first segment configured to engage an inner edge of a rim including an annular member that extends inwardly adjacent an upper edge of a sidewall of a first paint container. The plurality of edge surfaces of the container engagement section include a second segment configured to engage an inner sidewall portion of the first paint container extending below the rim. The first orientation may be employed with a paint container that includes an annular rim for supporting a container lid.

In a second orientation of the support clip, the support clip is configured such that the leg extends downwardly adjacent an outer sidewall surface of a second paint container at the upper edge of the second paint container. The brush holder support section extends downwardly adjacent an inner sidewall surface of the second paint container extending vertically below the upper edge of the second paint container. The support clip is configured to grip the outer sidewall surface and the inner sidewall surface at the gap between the leg and the brush holder support section. The second orientation may be employed with a paint container that does not include a rim, such as a paint container from which a rim has been cut or otherwise removed.

In an embodiment, a brush keeper kit for a paint brush includes a paint container adapter and a brush holder. The paint container adapter includes an outer rim and an inner ledge, which define a lower section that is coupled to a lower paint container and an upper section that is coupled to an upper paint container of a brush keeper assembly. The brush holder is configured to be mounted to an upper interior portion of the lower paint container and configured to support the paint brush within an interior space of the brush keeper assembly. The brush keeper kit of the disclosure enables painters to use paint containers as brush keeper parts to cover paint brushes, paint rollers, or other painting implements when not in use for wet storage.

In an embodiment, a paint container adapter includes a cylindrical outer rim and an inner ledge, wherein the outer rim and inner ledge define a lower section of the paint container adapter and an upper section of the paint container adapter. The lower section of the paint container adapter is configured to fit over a periphery of an open upper end of a lower paint container that faces upwardly. The upper section of the paint container adapter is configured to fit under a periphery of an open end of an upper paint container that is inverted to face downwardly. The paint container adapter, the lower paint container, and the upper paint container define an interior space configured to store a paint applicator. The paint container adapter is configured to seal the periphery of the open upper end of the lower paint container and the periphery of the open end of the upper paint container to inhibit escape of any vapor within the interior space.

In various embodiments, the paint can adapter further includes a brush holder configured to be mounted to an upper interior portion of the lower paint container and configured to support a paint brush within the interior space. In an embodiment, the brush holder includes a container engagement section comprising a plurality of edge surfaces configured for mounting the brush holder clip to the upper interior portion of the lower paint container.

In use of the paint container adapter, a first, lower paint container is placed in its normal orientation, and a second, upper paint container is placed over the first container in an inverted configuration with the open face of the upper container aligned with the open face of the lower container. The paint container adapter fits over the periphery of the open upper end of the lower paint container that faces upwardly and fits under the periphery of the open end of the upper paint container that is inverted to face downwardly. The paint container adapter, lower paint container, and upper paint container define an interior space. The paint container adapter is configured to seal the periphery of the open upper end of the lower paint container and the periphery of the open end of the upper paint container to prevent or limit release of vapors within the interior space. In an embodiment, the paint container adapter further includes a brush holder and a user may store a paint brush suspended from the brush holder within the interior volume of the lower container. In an embodiment, the paint container adapter is included in a keeper kit in which a user may store a paint brush, paint roller, or other article resting on interior surface(s) of the lower container.

In an embodiment, a support clip comprises a flat member including a container engagement section comprising a plurality of edge surfaces configured for mounting the support clip to an upper interior portion of a paint container, and a brush holder support section configured for mounting a paint brush holder to the support clip and for supporting the paint brush holder, wherein the upper interior portion of the paint container comprises a rim comprising an annular member extending inwardly from an upper edge of a sidewall of the paint container, and further comprises an inner sidewall surface of the container extending below the rim, and wherein the plurality of edge surfaces of the container engagement section comprise a first segment configured to engage the inner sidewall surface of the container extending below the rim and a second segment configured to engage an inner edge of the annular rim that extends inwardly from the upper edge of the sidewall of the paint container.

In an embodiment, a brush keeper kit for a paint brush comprises a paint container adapter, comprising an outer rim and an inner ledge, wherein the outer rim and inner ledge define a lower section of the paint container adapter and an upper section of the paint container adapter, wherein the lower section of the paint container adapter is configured to fit over a periphery of an open upper end of a lower paint container that faces upwardly, and the upper section of the paint container adapter is configured to fit under a periphery of an open end of an upper paint container that is inverted to face downwardly, and wherein the paint container adapter, the lower paint container, and the upper paint container define an interior space, and the paint container adapter is configured to seal the periphery of the open upper end of the lower paint container and the periphery of the open end of the upper paint container to inhibit escape of any vapor within the interior space; and a brush holder configured to be mounted to upper interior portion of the lower paint container and configured to support the paint brush within the interior space.

In an embodiment, a paint container adapter comprises a cylindrical outer rim and an inner ledge, wherein the outer rim and inner ledge define a lower section of the paint container adapter and an upper section of the paint container adapter, wherein the lower section of the paint container adapter is configured to fit over a periphery of an open upper end of a lower paint container that faces upwardly, and the upper section of the paint container adapter is configured to fit under a periphery of an open end of an upper paint container that is inverted to face downwardly, and wherein the paint container adapter, the lower paint container, and the upper paint container define an interior space configured to store a paint applicator, and the paint container adapter is configured to seal the periphery of the open upper end of the lower paint container and the periphery of the open end of the upper paint container to inhibit escape of any vapor within the interior space.

In an embodiment, a support clip comprises a flat member including a container engagement section comprising a plurality of edge surfaces, a brush holder support section configured for mounting a paint brush holder to the support clip and for supporting the paint brush holder, and a leg extending from the flat member adjacent the brush holder support section and defining a gap between the leg and the brush holder support section, wherein in a first orientation of the support clip, the support clip is configured such that the plurality of edge surfaces of the container engagement section comprise a first segment configured to engage an inner edge of a rim comprising an annular member that extends inwardly adjacent an upper edge of a sidewall of a first paint container and a second segment configured to engage an inner sidewall portion of the first paint container extending below the rim comprising the annular member extending inwardly adjacent the upper edge of a sidewall of the first paint container, and wherein in a second orientation of the support clip, the support clip is configured such that the leg extends downwardly adjacent an outer sidewall surface of a second paint container at the upper edge of the second paint container and the brush holder support section extends downwardly adjacent an inner sidewall surface of the second paint container extending vertically below the upper edge of the second paint container, wherein the support clip is configured to grip the outer sidewall surface and the inner sidewall surface at the gap between the leg and the brush holder support section.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1A is a front elevation view of a support clip for a paint container, according to the embodiment of FIGS. 1A-1E.

FIG. 1B is a top plan view of a support clip for a paint container, according to the embodiment of FIGS. 1A-1E.

FIG. 1C is a bottom plan view of a support clip for a paint container, according to the embodiment of FIGS. 1A-1E.

FIG. 1D is a perspective view of a support clip for a paint container, according to the embodiment of FIGS. 1A-1E.

FIG. 1E is an inward-facing side elevation view of a support clip for a paint container, according to the embodiment of FIGS. 1A-1E.

FIG. 2A is a bottom plan view of a brush holder, according to the embodiment of FIGS. 2A-2E.

FIG. 2B is a front elevation view of a brush holder, according to the embodiment of FIGS. 2A-2E.

FIG. 2C is an inward-facing side elevation view of a brush holder, according to the embodiment of FIGS. 2A-2E.

FIG. 2D is a perspective view of a brush holder, according to the embodiment of FIGS. 2A-2E.

FIG. 2E is an outward-facing side elevation view of a brush holder, according to the embodiment of FIGS. 2A-2E.

FIG. 3A is a front elevation view of brush holder/clip support assembly, according to the embodiment of FIGS. 3A-3D.

FIG. 3B is a bottom plan view of brush holder/clip support assembly, according to the embodiment of FIGS. 3A-3D.

FIG. 3C is a perspective view of brush holder/clip support assembly, according to the embodiment of FIGS. 3A-3D.

FIG. 3D is an outward-facing side elevation view of brush holder/clip support assembly, according to the embodiment of FIGS. 3A-3D.

FIG. 4A is a plan view of a paint container adapter, according to the embodiment of FIGS. 4A-4C.

FIG. 4B is a sectional view of a paint container adapter in a section taken through the diameter A-A of FIG. 4A, according to the embodiment of FIGS. 4A-4C.

FIG. 4C is a perspective view of a paint container adapter, according to the embodiment of FIGS. 4A-4C.

FIG. 5A is a front elevation view of a support clip for a paint container, according to the embodiment of FIGS. 5A-5B.

FIG. 5B is a perspective elevation view of a support clip for a paint container, according to the embodiment of FIGS. 5A-5B.

FIG. 6A is an elevation view of a brush keeper assembly including upper and lower paint containers, according to the embodiment of FIGS. 6A, 6B, 6D.

FIG. 6B is a sectional view of a brush keeper assembly in a section taken through the central vertical plane B-B of FIG. 6A, according to the embodiment of FIGS. 6A, 6B, 6D.

FIG. 6C is a sectional view of upper sidewall and rim of an illustrative paint container, according to an embodiment.

FIG. 6D is a sectional view of a brush keeper assembly at the area C of the sectional view of FIG. 6B showing a close-up view at the junction of upper and lower paint containers, according to the embodiment of FIGS. 6A, 6B, 6D.

FIG. 7A is a plan view of a paint container adapter, according to the embodiment of FIGS. 7A-7D.

FIG. 7B is a perspective view of a paint container adapter, according to the embodiment of FIGS. 7A-7D.

FIG. 7C is a sectional view of a paint container adapter in a section taken through the diameter D-D of FIG. 7A, according to the embodiment of FIGS. 7A-7D.

FIG. 7D is a sectional view of a portion of a paint container adapter at the area E of the sectional view of FIG. 7C, according to the embodiment of FIGS. 7A-7D.

FIG. 8 is a sectional view of a brush keeper assembly without brush holder, according to an embodiment.

FIG. 9A is a front elevation view of a support clip for a paint container, according to the embodiment of FIGS. 9A-9D.

FIG. 9B is a perspective view of a support clip for a paint container, according to the embodiment of FIGS. 9A-9D.

FIG. 9C is an outward-facing side elevation view of a support clip for a paint container, according to the embodiment of FIGS. 9A-9D.

FIG. 9D is an inward-facing side elevation view of a support clip for a paint container, according to the embodiment of FIGS. 9A-9D.

FIG. 10 is a sectional close-up view of a support clip mounted to a paint container in a first orientation of the support clip, according to an embodiment.

FIG. 11A is an elevation view of a paint container with support clip, brush holder and paint brush mounted in a second orientation of the support clip, according to the embodiment of FIGS. 11A-11C.

FIG. 11B is a sectional view of a paint container with support clip, brush holder and paint brush mounted in a second orientation of the support clip, in a section taken through the central vertical plane F-F of FIG. 11A, according to the embodiment of FIGS. 11A-11C.

FIG. 11C is a perspective view of a paint container with support clip, brush holder and paint brush mounted in a second orientation of the support clip, according to the embodiment of FIGS. 11A-11C.

### DETAILED DESCRIPTION

The present disclosure is here described in detail with reference to embodiments illustrated in the drawings which form a part here. Other embodiments may be used and/or other changes may be made without departing from the spirit or scope of the present disclosure. The illustrative embodiments described in the detailed description are not meant to be limiting of the subject matter presented here.

Reference will now be made to the exemplary embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to one skilled in the relevant art and having possession of this disclosure, are to be considered within the scope of the invention.

When using containers of paint and paint brushes, professional painters and other users also often employ painting accessories to facilitate painting. One type of painting accessory is brush holders that can be used for organizing and storing paint brushes. Another type of painting accessory is brush keepers that cover paint brushes when not in use and allow for wet storage of paint brushes. Using brush keepers, when painters take a break they may not have to wash their brushes. As used in the present disclosure, brush keeper may also refer to painting accessories that can be used for organizing and storing other painting implements besides paint brushes, such as paint rollers.

Disclosed embodiments of a support clip/brush holder assembly and a brush keeper kit provide various advantages over conventional painting accessories. In disclosed embodiments, the support clip/brush holder assembly of the disclosure can be easily mounted to the rim and inner sidewall surface of a typical paint container to be securely supported by these container structures. The support clip/brush holder assembly of the disclosure retains brushes within an interior space of a paint can or of an interior space defined by multiple paint cans. Support clip/brush holder assemblies of the disclosure can hold one or more paint brushes suspended in a vertical orientation within a paint container. Due to these characteristics, disclosed embodiments of the support clip/brush holder assembly may be employed as a component of the brush keeper kit of the present disclosure.

In disclosed embodiments, the support clip is a flat member that includes a container engagement section having a plurality of edge surfaces configured to mount to an upper interior portion of a paint container, and that further includes a brush holder support section. The brush holder support section of the support clip carries a brush holder within the interior of the paint container. The brush holder is configured to hold a paint brush suspended from the brush holder. In the present disclosure, brush holder and paint brush holder refer to a member configured for holding a paint brush.

In commercial paint containers for storing paint, the upper interior portion has a fairly standard configuration across a range of sizes, types, and constituent materials of paint cans and buckets. An annular element extends radially inwardly from the upper end of the container's sidewall. In the present disclosure, this annular element is generally referred to as the rim. The annular rim is configured to hold a lid to close the paint container. In the present disclosure, this type of paint container is sometimes referred to as a paint container with rim.

Another common type of paint container does not include an annular rim. In the present disclosure, this type of paint container is sometimes referred to as a paint container without rim. In an embodiment, a paint container without rim is a paint container from which the rim has been removed. The rim of a conventional paint container can get in the way of properly loading the paint brush. It is common practice of professional painters to cut the annular rim from a commercial paint container, forming a paint container sometimes called a cut bucket. Removal of the rim results in an inner sidewall surface extending vertically below the upper edge of the paint container.

In disclosed embodiments for mounting a support clip to a paint container with rim, the support clip of the disclosure is configured to engage an inner edge of the rim and an inner sidewall surface of the paint container just below the rim, and may further engage a lower surface of the rim. A container engagement section of the support clip includes various edge surfaces configured to engage these container surfaces.

The edge surfaces of the container engagement section of the support clip include a first segment configured to engage an inner sidewall surface of the container extending below the rim, and a second segment configured to engage an inner edge of the container rim. The edge surfaces may further include an intermediate segment extending between the first segment and the second segment, wherein the intermediate segment is configured to engage a lower surface of the rim. In an embodiment, the second segment includes a hook configured to fit over an upper lip at the inner edge of the rim, and a portion of the second segment is configured to engage an inner edge surface at the inner edge of the rim. In an embodiment, the first segment and the intermediate segment form a convex angular member configured to fit into a recess at a lower surface of the rim adjacent the sidewall. In an embodiment, the first segment includes a protrusion configured to abut against the inner sidewall surface of the container in order to adjust orientation of the support clip. In an embodiment, the support clip snaps into place and is frictionally retained by the rim and the sidewall.

In other disclosed embodiments, the support clip includes two orientations to mount the support clip to different types of paint container. In the present disclosure, this support clip embodiment is sometimes referred to as a dual orientation support clip. The dual orientation support clip includes a flat member including a container engagement section comprising a plurality of edge surfaces, a brush holder support section configured for mounting a paint brush holder to the support clip and for supporting the paint brush holder, and a leg extending from the flat member adjacent the brush holder support section. The support clip defines a gap between the leg and the brush holder support section.

In a first orientation of the support clip, the support clip is configured such that the plurality of edge surfaces of the container engagement section include a first segment configured to engage an inner edge of a rim including an annular member that extends inwardly adjacent an upper edge of a sidewall of a first paint container. The plurality of edge surfaces of the container engagement section include a second segment configured to engage an inner sidewall portion of the first paint container extending below the rim. The first orientation may be employed to mount the support clip to a paint container with rim.

In a second orientation of the support clip, the support clip is configured such that the leg extends downwardly adjacent an outer sidewall surface of a second paint container at the upper edge of the second paint container. The brush holder support section extends downwardly adjacent an inner sidewall surface of the second paint container extending vertically below the upper edge of the second paint container. The support clip is configured to grip the outer sidewall surface and the inner sidewall surface at the gap between the leg and the brush holder support section. The second orientation may be employed to mount the support clip to a paint container without rim.

In an embodiment, the dual orientation support clip further includes a paint brush holder mounted to the brush holder support section. The paint brush holder is configured for holding a handle of a paint brush with bristles of the paint brush suspended substantially vertically below the paint brush holder. In an embodiment, the paint brush holder is mounted to the brush holder support section via pin and socket joint.

In an embodiment of the dual orientation support clip, the plurality of edge surfaces of the first paint container engagement section further include an intermediate segment extending between the first segment and the second segment. The intermediate segment is configured to engage a lower surface of the rim in the first orientation of the support clip. The first segment may include a hook configured to fit over an upper lip at the inner edge of the rim. The second segment may include a portion configured to engage an inner edge surface at the inner edge of the rim in the first orientation of the support clip. The second segment may include a protrusion configured to abut against the inner sidewall portion of the paint container with rim in order to adjust orientation of the support clip in the first orientation of the support clip.

In an embodiment of the dual orientation support clip, the support clip defines a round opening at an interior end of the gap between the leg and the brush holder support section. The round opening may be configured to fit over a bead at the upper edge of the second paint container in the second orientation of the support clip.

In various embodiments, in the first orientation of the support clip, the support clip is frictionally retained by the inner sidewall portion and the inner edge of the rim of the paint container. In the second orientation of the support clip, the support clip is frictionally engaged by the outer sidewall surface and the inner sidewall surface of a paint container. In various embodiments, the second orientation of the dual-orientation support clip is configured to engage a paint container without rim or a paint container from which a rim has been removed.

The brush keeper kit of the disclosure enables painters to use paint containers as brush keeper parts to cover paint brushes when not in use for wet storage of paint brushes. The brush keeper kit allows a painter to store one or more paint brushes, paint rollers, or other painting implements in an interior space defined by first and second paint containers stacked in an open end-to-end configuration with lids of both containers removed. A first, lower paint container is placed in its normal orientation, and a second, upper paint container is placed over the first container in an inverted configuration with the open face of the upper container aligned with the open face of the lower container. The brush keeper kit includes a paint container adapter that fits over the periphery of the open upper end of the lower paint container that faces upwardly and that fits under the periphery of the open end of the upper paint container that is inverted to face downwardly. The paint container adapter connects the upper and lower containers in a stacked configuration.

In an environmentally-friendly arrangement, the brush keeper kit of the disclosure enables painters to employ materials at hand such as used paint cans or paint buckets. The brush keeper kit of the disclosure permits storage of paint brushes in paint containers between painting sessions, thereby saving time.

The brush keeper kit of the disclosure may include a brush holder configured to hold one or more paint brushes within the brush keeper interior space. In an embodiment, the brush holder is secured to the lower paint container and holds a paint brush suspended below the brush holder. In an embodiment, the brush holder is secured to an inner sidewall surface and rim of the lower container. In an embodiment, the brush keeper kit includes the support clip/brush holder assembly of the disclosure.

The paint container adaptor together with the upper and lower paint containers define an interior space for wet storage of one or more paint brushes. The present disclosure sometimes uses the term “brush keeper interior space” to describe the interior regions of upper and lower paint containers stacked in an open end-to-end configuration with the paint container adapter of the disclosure. In a use case of wet storage using the brush keeper kit of the disclosure, one or more paint brushes, paint rollers, or other painting implements may be stored at least partially immersed in liquid stored in the lower paint container, such as in paint or solvent. In a use case of wet storage using the brush keeper kit of the disclosure, one or more paint brushes may be stored with bristles suspended above liquid stored in the lower paint container, such as in volatile vapors within the brush keeper interior space. The interface between paint container adapter and upper and lower paint containers serves as a barrier to evaporation of volatile materials such as aqueous or non-aqueous paints and solvents. The paint container adapter of the disclosure prevents or limits loss of volatile materials during a time interval of wet storage.

In disclosed embodiments, the paint container adapter includes a circular cylindrical ring. The paint container adapter may include a circular cylindrical rim and an annular inner ledge.

In disclosed embodiments, the paint container adaptor is configured for storage of a paint brush, and further includes a brush holder configured to be mounted to upper interior portion of the lower paint container and configured to support the paint brush within the interior space. The brush holder may include a brush holder support section. The brush holder may include a container engagement section including a plurality of edge surfaces configured for mounting the brush holder clip to the upper interior portion of the lower paint container. The plurality of edge surfaces may be configured for mounting the brush holder to an inner edge of an annular rim that extends inwardly from the periphery of the open upper end of the lower paint container and for mounting the brush holder to an inner sidewall surface of the lower paint container. In an embodiment, the brush holder is configured to support a handle of the paint brush with bristles of the paint brush suspended substantially vertically below the brush holder.

In an embodiment, a brush keeper incorporating the paint container adapter is configured for storage of a paint roller in the lower paint container.

In an embodiment of the paint container adapter, wherein the lower section of the paint container adapter is configured to fit over a bead that extends around the periphery of the open upper end of the lower paint container. The upper section of the paint container adapter is configured to fit under a bead that extends around the periphery of the open end of the upper paint container.

In an embodiment of the paint container adapter, interior surfaces of the outer rim include bumps to aid retention of the lower container within the lower section and to aid retention of the upper container within the upper section.

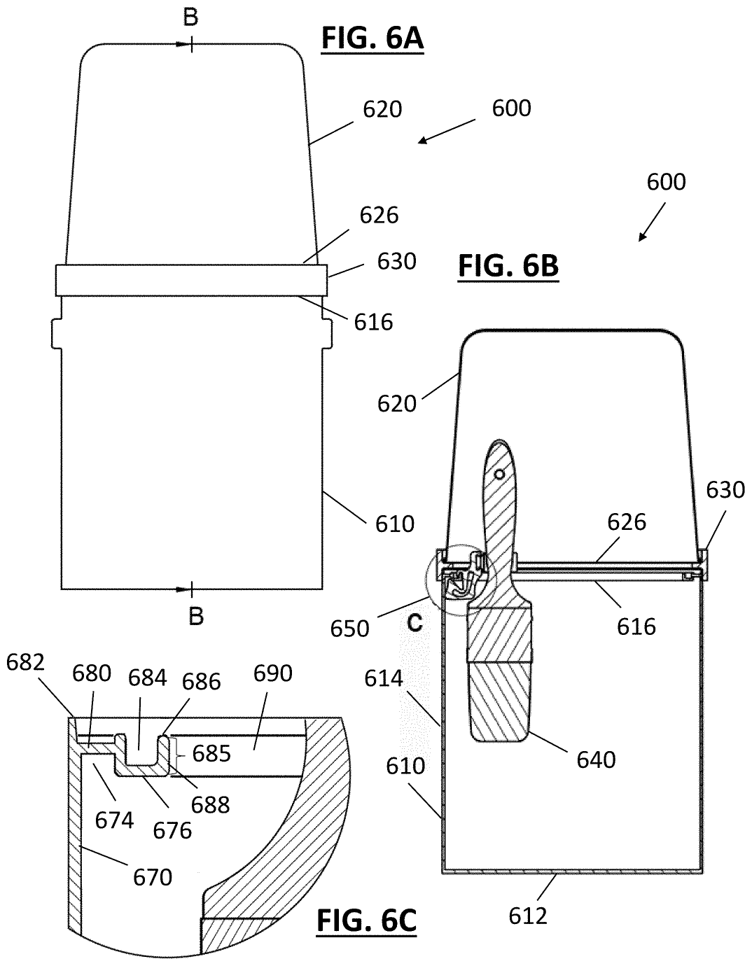

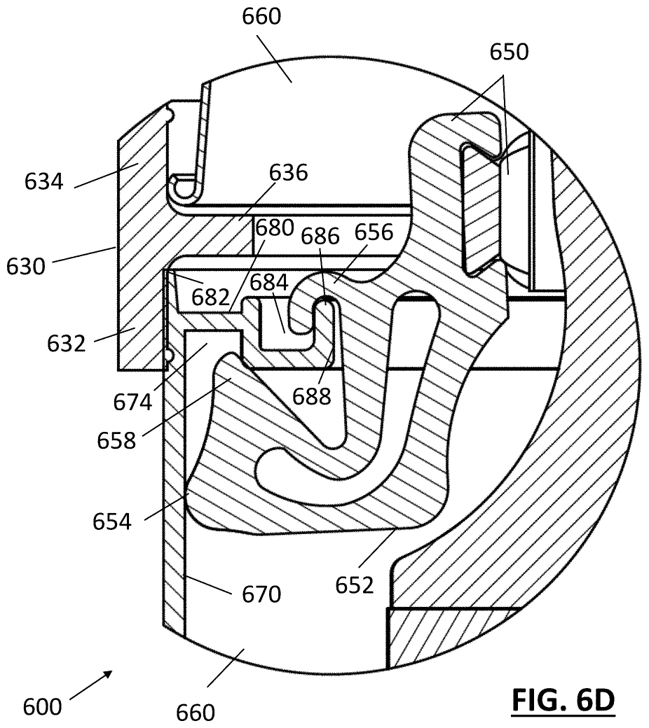

In typical manufacture of a paint container 610 (also referred to herein as a paint can or paint bucket) as seen in FIG. 6B, the container includes a sidewall 614 extending from a base 612 to a top edge 616. As seen in FIG. 6C, at the top edge 682 of the sidewall, the container includes a bead that extends around the periphery of the upper end of the container. In a paint container with rim, the container includes a radially inwardly extending annular rim 680 secured to the top edge 682 of the sidewall 614 of the container. The rim 680 extends radially inwardly from a major (outer) diameter to a minor (inner) diameter. In the present disclosure, structure of the rim at the minor (inner) diameter is sometimes referred to as the inner edge of the rim. An upper portion of the inner edge 685 may include a lip 684. A side portion of the inner edge 685 may define an inner edge surface 688 of the rim 680.

The rim 680 may include a seaming panel for attachment to a side wall of the container by mechanical crimping or rolled seaming to a can flange adjacent the outer edge of the rim. An upper surface of the rim may define a ring groove 684 extending in a circular path entirely around the ring element between the major and minor diameters of the ring. A lower surface 676 of the rim 680 extends from a junction to sidewall surface 670 of the container to the inner edge 685 of the rim. The rim may include a recess 674 adjacent the junction of the rim 680 to the inner sidewall surface 670.

An area at the top of the container that is not covered by the rim 680 defines a circular container opening 690, providing access to interior space of the container. Typically, a paint container lid (not shown in the drawings) is friction fit onto the rim 680 covering the opening 690. The lid may include a central downward projection that fits tightly in the circular can opening, and may include an annular protrusion sized to fit snugly within the ring groove 684 of the rim. In the brush keeper assembly of the disclosure as shown in FIG. 6D, the lids of lower paint container 610 and upper paint container 620 are both removed so that an opening of lower paint container 610 faces a corresponding opening of upper paint container 620 in an open end-to-end configuration, resulting in a shared interior space 660.

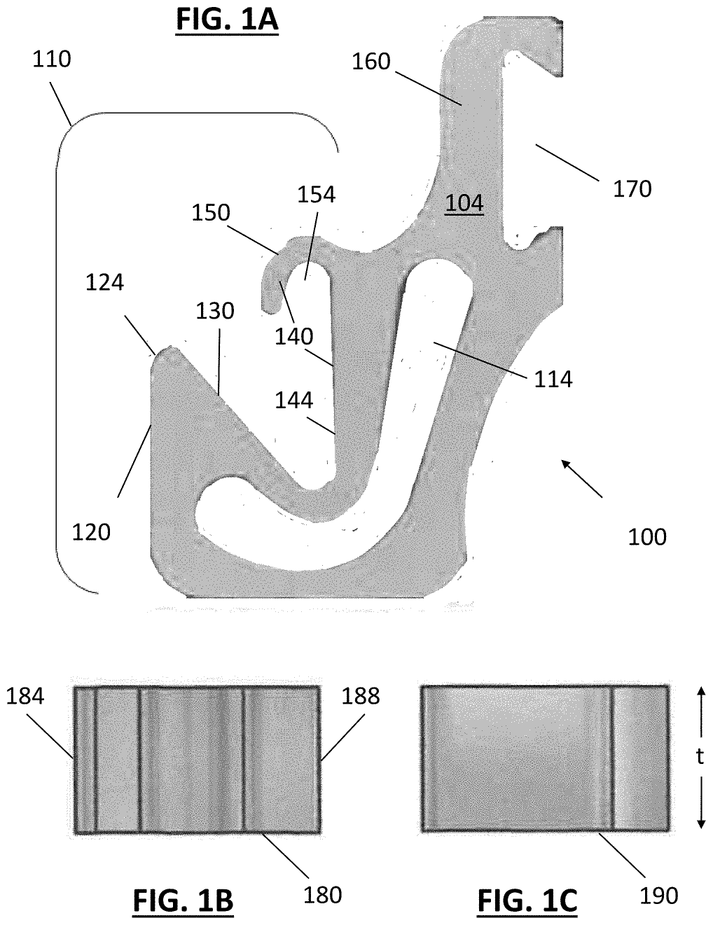

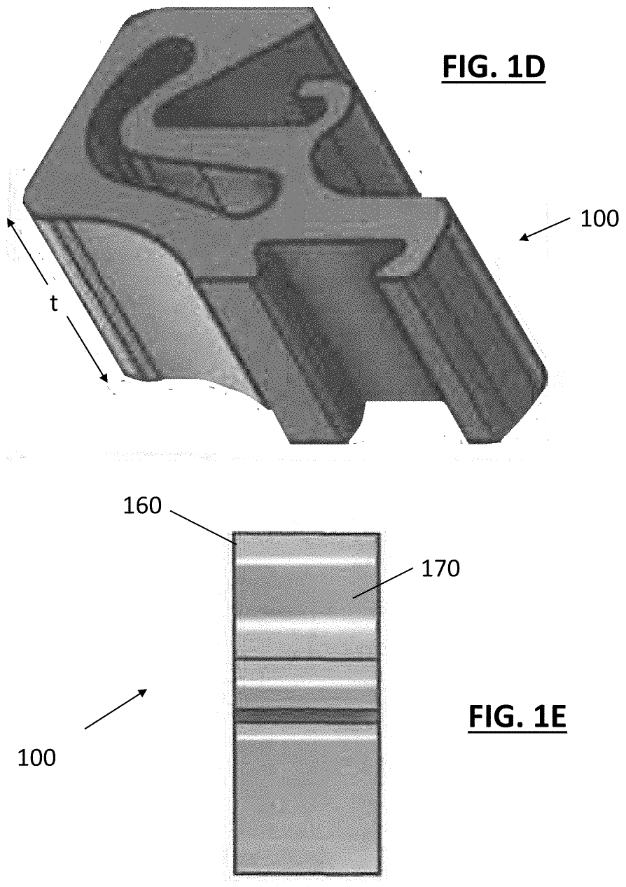

In various embodiments, the support clip/brush holder assembly of the disclosure includes a support clip mounted to the container, and a brush holder mounted to the support clip. FIGS. 1A-1E show an embodiment of a support clip 100. Support clip 100 includes a container engagement section 110 that includes various structures configure to mount the support clip to the container, and a brush holder support section 160 configured to carry a paint brush within the interior space of the paint container. The container engagement section includes a first segment 120, a second segment 140, and an intermediate segment 130 extending between the first segment 120 and second segment 140. In an embodiment, the first segment 120 is configured to engage inner sidewall surface 670 of a container. The second segment 140 is configured to engage the inner edge 685 of the rim 680. The second segment 140 is configured to engage the inner edge 685 of the rim 680. The second segment 140 may include a hook 150 defining an aperture 154 that is configured to engage the lip 684, and may include a straight portion 144 configured to engage the inner edge surface 688 of the rim.

In an embodiment, the container engagement section 110 of support clip 100 further includes an intermediate segment 130 that extends between the first segment 120 and the second segment 140. The intermediate segment may be configured to one or more structure at the lower surface 676 of the rim 680. In an embodiment, the first segment 120 and intermediate segment 130 are alighted at an acute angle forming a convex angular portion of the container engagement section 110. The first segment 120 and intermediate segment 130 may meet at a corner 124, which may include a rounded surface. In an embodiment, the intermediate surface 130 and corner 124 are configured to engage the recess 674 adjacent the junction to the inner sidewall surface 670, e.g., as shown in FIG. 6D. During installation, the support clip 100 may snap in place at the recess 674 and be frictionally retained by the rim 680 and the sidewall inner surface 670.

The support section 160 includes a junction 170 for joining the support clip to a brush holder. In an embodiment, the junction 170 is a socket of a pin-and-socket joint or dovetail joint. In an embodiment, the container engagement section 110 of support clip 100 is located at an outward facing portion of the support clip to face various structures of the container, while the brush holder support section 160 of support clip 100 is located at an inward-facing portion of the support clip to support a brush holder adjacent the central axis of the container. In an embodiment, the support section 160 is located above the container engagement section when the support clip is mounted to a paint container in its normal orientation.

As used in the present disclosure, “inward” and “outward” are relative terms for interior locations within a paint container. In an embodiment “inward” means closer to the central axis of a paint container and “outward” means further away from the central axis of the paint container. In an embodiment, “inward” and “outward” are relative terms for locations along a radius of a right circular cylinder. As used in the present disclosure, “central axis” refers to a central line segment extending in axial direction of a paint container. In an embodiment, “central axis” of a paint container refers to the axis of a right circular cylinder.

The support clip 100 may include a flat strip 104 of a hard material such as metal, polymeric material, or metal-polymer composite. The support clip 100 may be patterned with a cut-away portion 114 to reduce its weight and to improve mechanical properties. The support clip may be produced using various forming processes, such as molding, die cutting, and ink jet printing.

FIG. 1B is a top plan view of the support clip 100. FIG. 1C is a bottom plan view of a support clip 100. As shown in these views, the support clip 100 includes a thickness t alongside edge surfaces, such as side edges 184, 188. By virtue of its thickness, the support clip 100 extends along an arc of a circumference or circular cross section of a container, such as a paint container in the form of a right circular cylinder. As used in the present disclosure, “arc” refers to a portion of a substantially circular periphery of a circular cylindrical container. In an embodiment, “arc” refers to a portion of a circle concentric to a substantially circular periphery of a circular cylindrical container. A plurality of support clips may be mounted at different positions around the container circumference, to hold more than one brush holder/paint brush within a container.

FIG. 1D is a perspective view of the support clip 100 for a paint container, showing the thickness t of the clip. FIG. 1E is an inward-facing side elevation view of a support clip 100 for a paint container showing the brush holder support section 160 and junction 170.

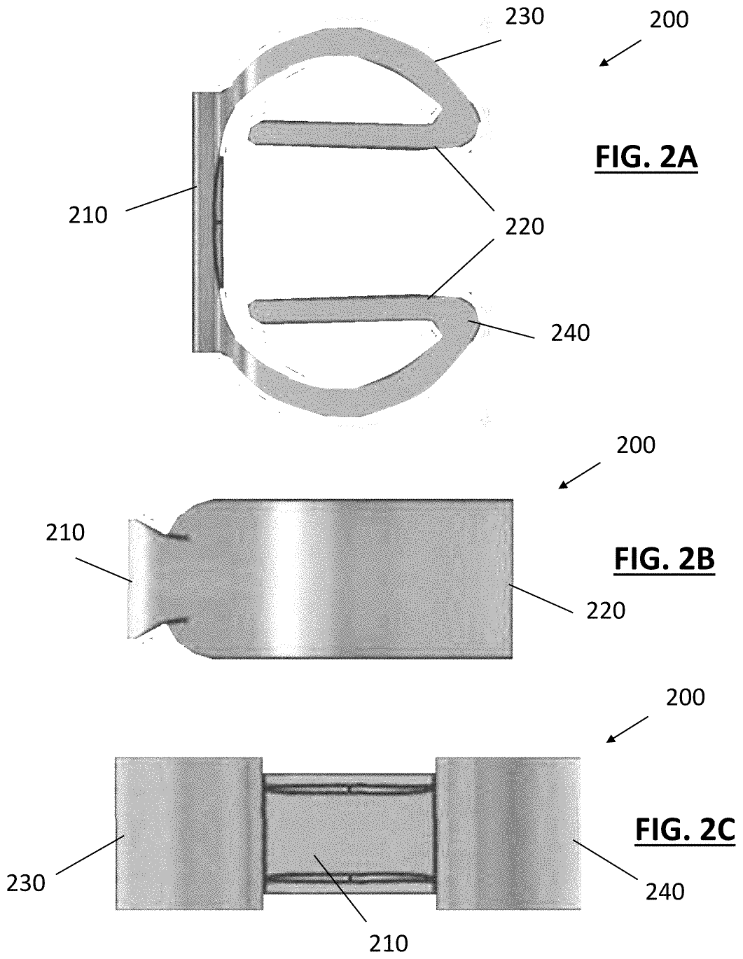

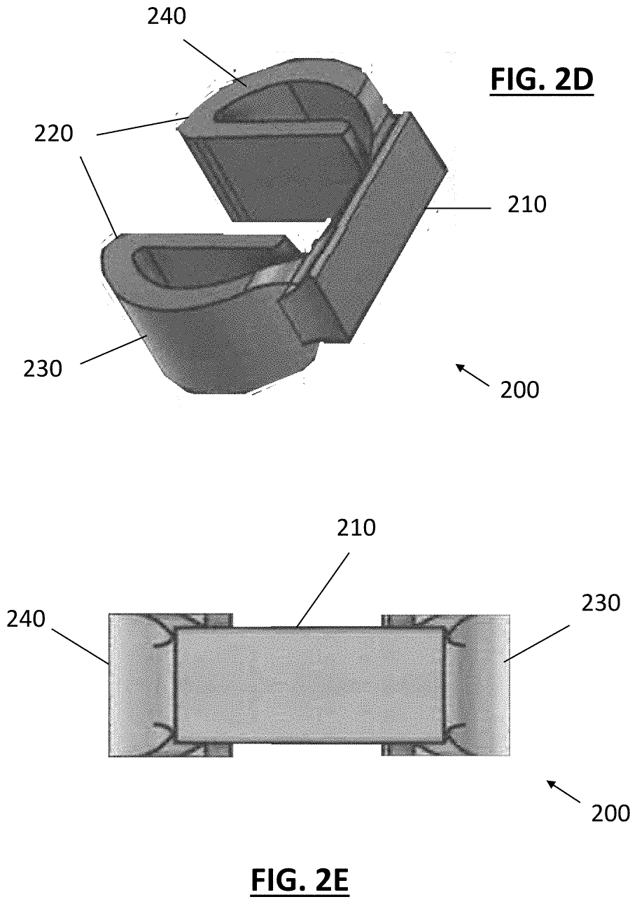

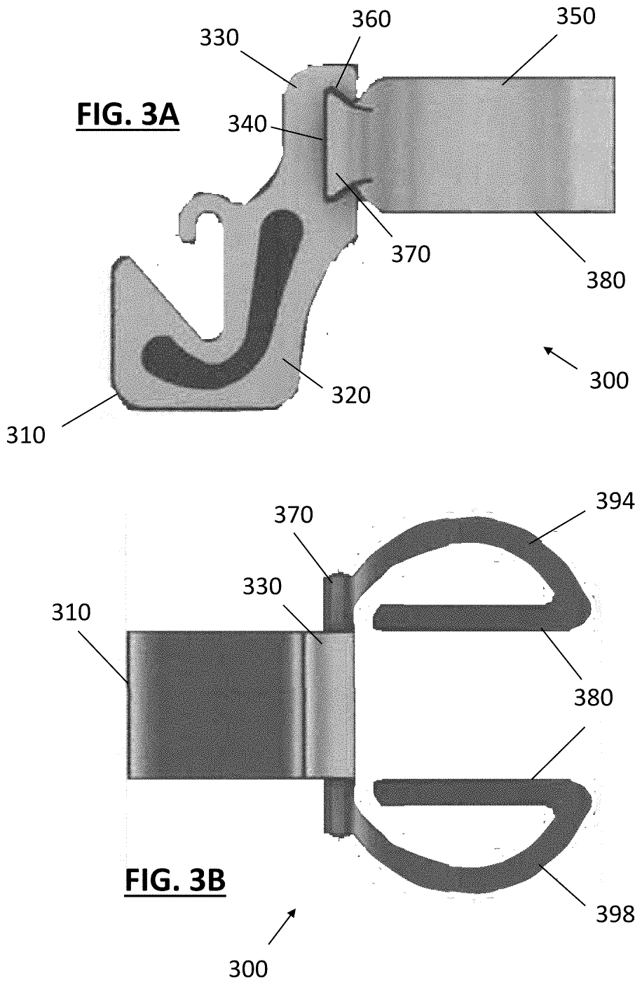

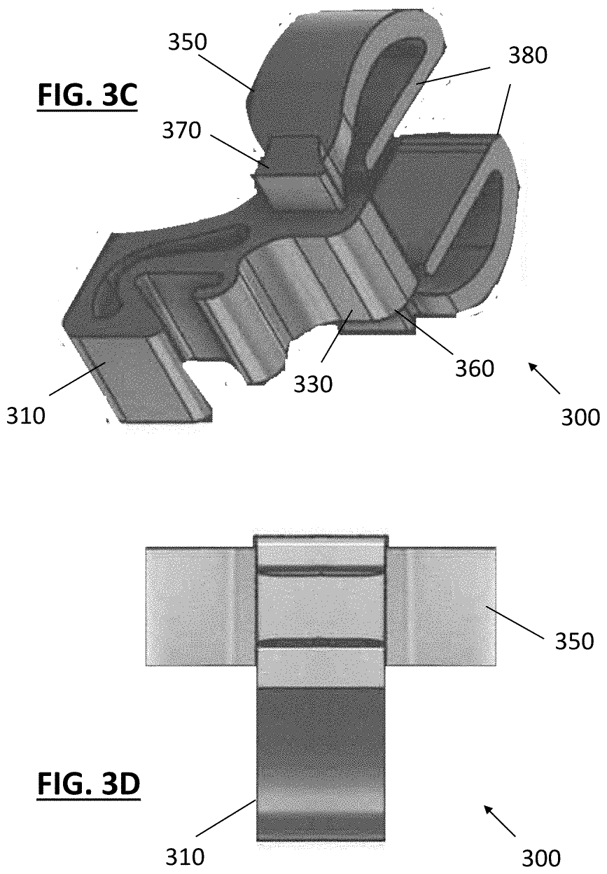

FIGS. 2A-2E show an embodiment of brush holder 200. Brush holder 200 is configured to be mounted to a support clip (e.g., support clip 100) to form a support clip-brush holder assembly (e.g., support clip-brush holder assembly 300 shown in FIGS. 3A-3D). Brush holder 200 includes a junction 210 and a gripper section 220. As seen in FIGS. 2A, 2D, the gripper section 220 includes opposing gripper arms 230, 240 configured to grip a handle of a paint brush. As seen in FIG. 2B, the junction 210 is a pin and socket joint or dovetail joint, configured to mate with the socket 170 of support clip 100. The dovetail joint of brush holder 200 contrasts with conventional gripper clips, which typically include fasteners for mounting the gripper clip to a flat surface. The brush holder may include various versions designed for different types and sizes of paint brushes, such as larger-sized professional paint brushes and smaller-sized artist or hobbyist paint brushes.

FIGS. 3A-3D show an embodiment of support clip-brush holder assembly 300. As shown in the front elevation view of FIG. 3A, brush holder 350 is mounted to support clip 310. Brush holder 350 includes gripper section 380 and pin 370 mounted within socket 340 of support clip 310. At the support clip-brush holder junction 360, the support clip 310 carries the brush holder 350 in an orientation in which the gripper section 380 including gripper arms 384, 398 extends along a generally horizontal axis (FIGS. 3A, 3B). Support clip-brush holder assembly 300 is thereby oriented to support a paint brush suspended vertically below the gripper section 380 (FIG. 3A, FIG. 6B). FIG. 3C shows a perspective view of brush holder/clip support assembly 300, and FIG. 3D is an outward-facing side elevation view of brush holder/clip support assembly 300.

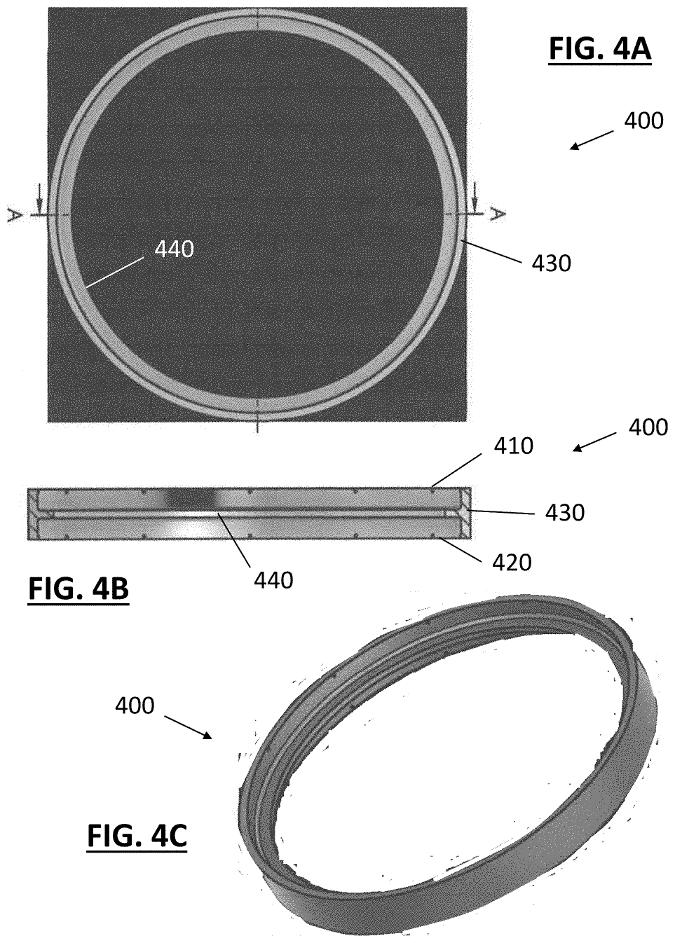

FIGS. 4A-4C illustrate an embodiment of paint container adapter 400. The cylindrical paint container adapter 400 is configured to fit to the circumference of an open end of a lower container and to the circumference of the lower open end of an upper can, as shown at 630 in FIG. 6A. The paint can adaptor is also referred to herein as paint can/bucket adapter and adapter ring. The adapter ring serves as a connector for the two cans. The paint can adapter includes an outer cylindrical rim 430 and an inner annular ledge 440, as seen in the plan view of a paint container adapter 400 of FIG. 4A. The rim 430 and annular ledge 440 define an upper portion 410 and a lower portion 420 of the adapter ring, as seen in FIG. 4B showing a sectional view of the adapter ring 400 in a section taken through the diameter A-A of FIG. 4A. FIG. 4C shows a perspective view of a paint container adapter 400.

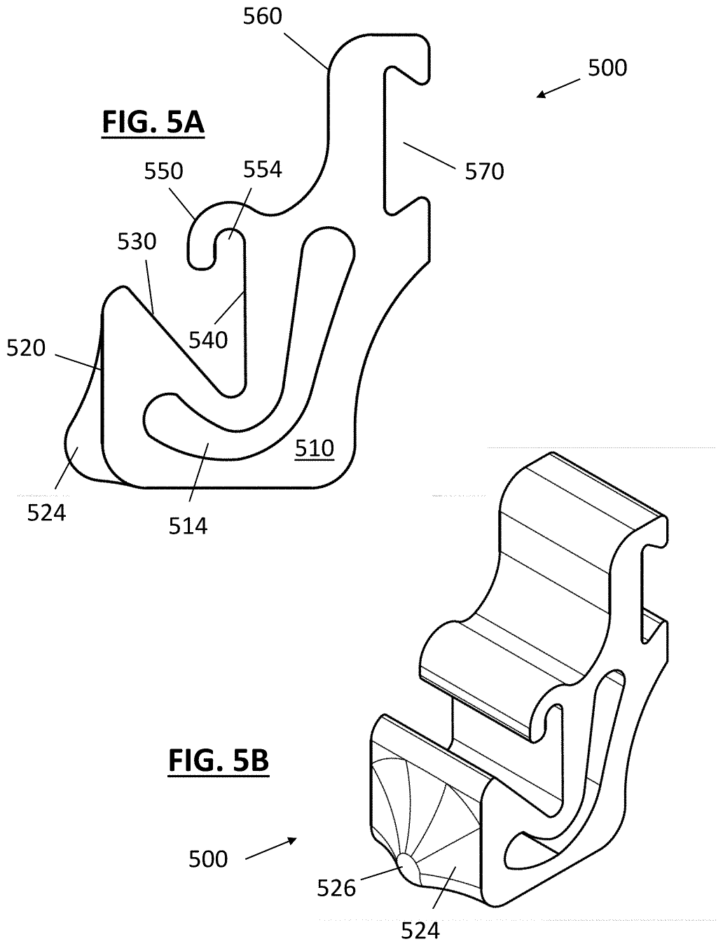

FIGS. 5A-5B show an embodiment of a support clip 500. The support clip 500 is generally similar to the support clip 100 shown in FIGS. 1A-1E. Reference should be had to the description of support clip 100 for details of corresponding structures of support clip 500. In addition, support clip 500 includes a protuberance 524 which is configured to offset the first segment 520 from the container inner sidewall surface to alter the orientation of the support clip 500. After mounting of the support clip 500 to the container, outer surface 526 of protuberance 524 abuts against the container inner sidewall surface. As seen in the support clip embodiment 652 of FIG. 6D, engagement of protuberance 654 with sidewall 670 orients the support clip-brush holder assembly 650 to support the paint brush 640 in a generally vertical orientation (FIG. 6B).

FIGS. 6A, 6B, and 6D show an embodiment of a brush keeper kit employed in a brush keeper assembly 600 for a paint brush. The brush keeper kit includes a paint container adapter and a brush holder 650. The brush keeper kit for a paint brush employs paint containers as brush keeper parts. The brush keeper kit enables painters to use paint containers as brush keeper parts to cover paint brushes when not in use and to provide for wet storage of paint brushes. As seen in the elevation view of FIG. 6A, the brush keeper assembly includes a lower paint container 610 and an upper paint container 620, coupled by a paint container adapter 630. The lower paint container 610 is placed in its normal orientation, and the upper paint container 620 is placed over the lower container 610 in an inverted configuration with the open face 624 of the upper container aligned with the open face 614 of the lower container. The paint container adapter 630 fits over the periphery of the open upper end 614 of the lower paint container that faces upwardly, and fits under the periphery of the open end 624 of the upper paint container that is inverted to face downwardly. The paint container adapter 630 connects the upper and lower containers 610, 620 in a stacked configuration.

FIG. 6B is a sectional view of a brush keeper assembly 600 in a section taken through the central vertical plane B-B of FIG. 6A. This section shows a sectional view of brush holder 650 supporting a paint brush 640. The brush holder 650 is configured to support a handle of the paint brush 640 with bristles of the paint brush suspended substantially vertically below the brush holder. In a use case of wet storage using the brush keeper kit 600, one or more suspended paint brushes 640 may be stored with bristles at least partially immersed in liquid stored in the lower paint container, such as in paint or solvent (not shown). In a use case of wet storage using the brush keeper kit of the disclosure, one or more paint brushes 640 may be stored with bristles suspended above liquid stored in the lower paint container, such as in volatile vapors within the brush keeper interior space. The interface between paint container adapter 630 and upper and lower paint containers 620, 610 serves as a barrier to evaporation of volatile materials such as paints and solvents. The paint container adapter 630 prevents or limits loss of volatile material during a time interval of wet storage.

FIG. 6D is a sectional view of a brush keeper assembly 600 at the area C of the sectional view of FIG. 6B showing a close-up view of the brush holder 650 and other structures at the junction of upper and lower paint containers. Reference may be had to descriptions of FIGS. 1A-1E and 5A-5B for a detailed description of edge surfaces of the container engagement section of the support clip 652. A first segment is configured to engage an inner sidewall surface 670 of the container extending below the rim 680, and a second segment is configured to engage an inner edge 685 of the container rim (FIG. 6C). The edge surfaces may further include an intermediate segment extending between the first segment and the second segment, wherein the intermediate segment is configured to engage a lower surface 676 of the rim (FIG. 6C). In an embodiment, the second segment includes a hook 656 configured to fit over an upper lip 686 at the inner edge of the rim, and a portion of the second segment is configured to engage an inner edge surface 688 at the inner edge of the rim. In an embodiment, the first segment and the intermediate segment form a convex angular member 658 configured to fit into a recess 674 at a lower surface of the rim adjacent the sidewall. In an embodiment, the first segment includes a protrusion 654 configured to abut against the inner sidewall surface 670 of the container in order to adjust orientation of the support clip. In an embodiment, the support clip 652 snaps into place and is frictionally retained by the rim and the sidewall.

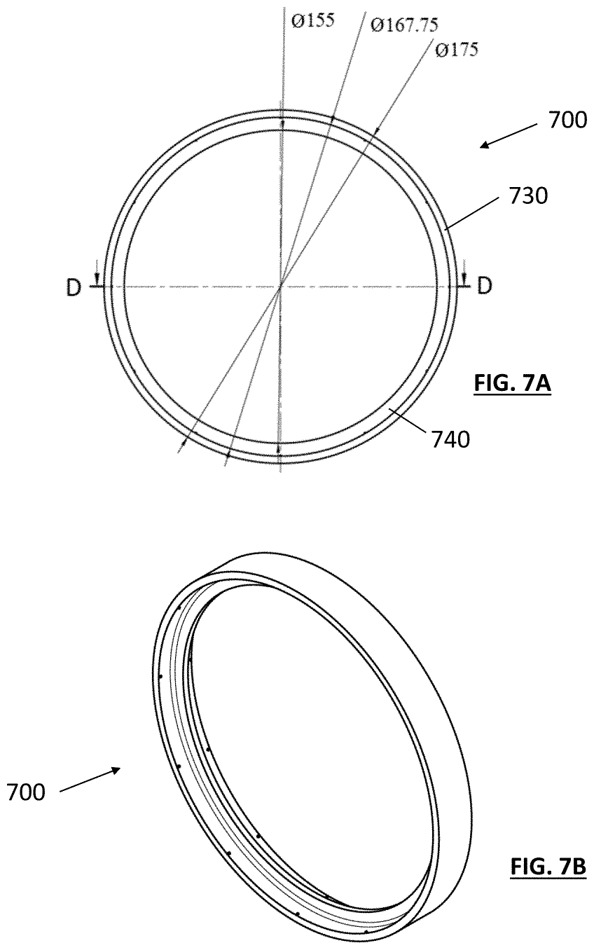

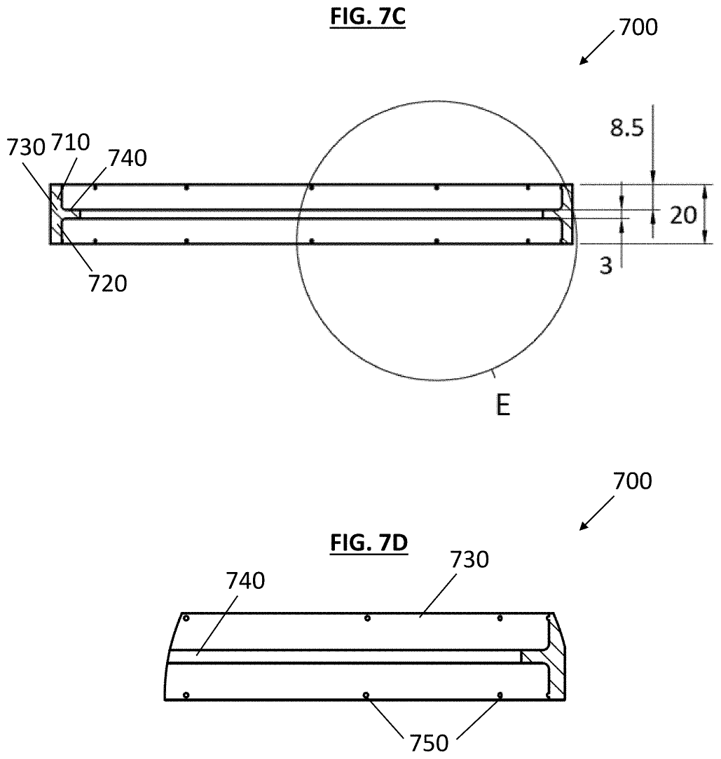

FIGS. 7A-7D show an embodiment of a paint container adapter 700. The paint container adapter 700 is generally similar to the paint container adapter 400 shown in FIGS. 4A-4C and reference should be had to the description of paint container adapter 400 for details of corresponding structures of paint container adapter 700. In addition, FIGS. 7A, 7C show illustrative dimensions of paint container adapter 700. The sectional view of FIG. 7C and the partial sectional view of FIG. 7D show interior surfaces of the outer rim 730 include bumps 750 to aid retention of the lower container within the lower section 720 and to aid retention of the upper container within the upper section 710.

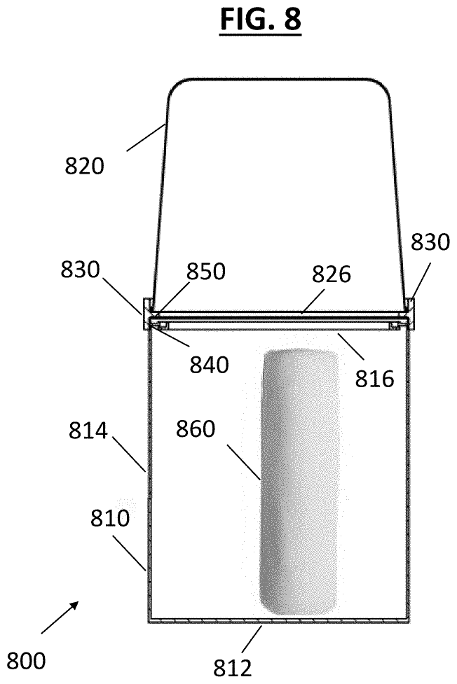

FIG. 8 is a sectional view of a brush keeper assembly 800 in a section taken through a central vertical plane. The brush keeper assembly 800 may be generally similar to the brush holder assembly 600 of FIG. 6B, but does not include a brush holder configured to support a paint brush suspended below the brush holder. Rather, the brush keeper assembly 800 may support an article such as paint roller without handle 860 resting on the floor 812 or other interior surface(s) of lower paint container 810. In a use case of wet storage using the brush keeper assembly 800, one or more paint brushes, paint rollers or other painting implements may be stored at least partially immersed in liquid stored in the lower paint container 810, such as in paint or solvent (not shown). The interface between paint container adapter 830 and upper and lower paint containers 820, 810 serves as a barrier to evaporation of volatile materials such as paints and solvents. The paint container adapter 830 prevents or limits loss of volatile material during a time interval of wet storage.

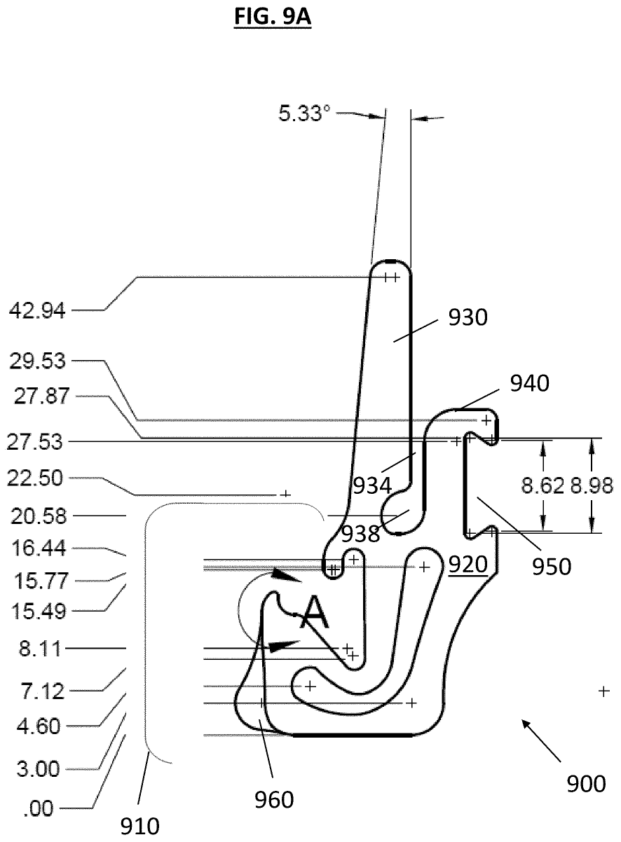

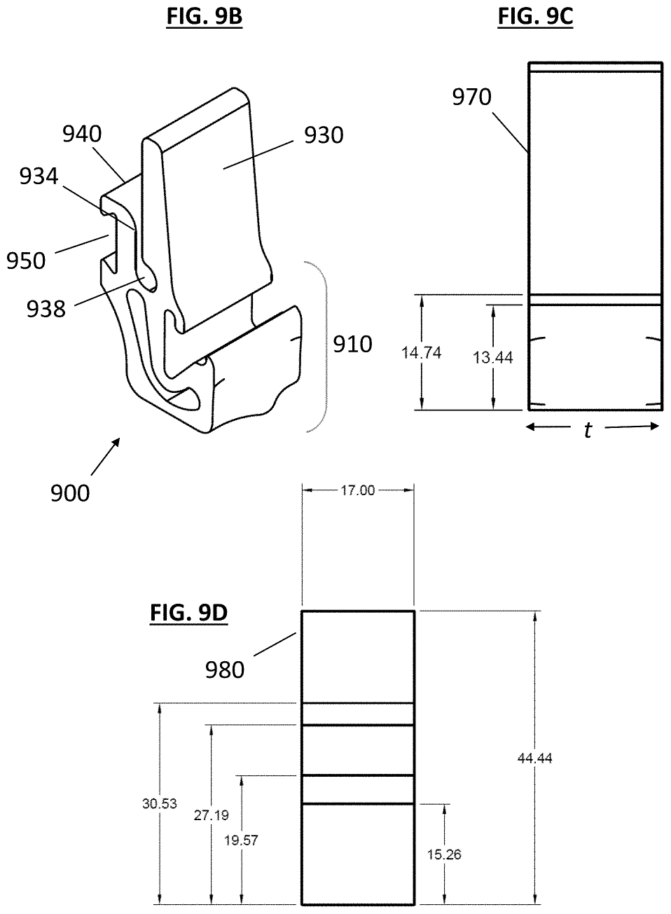

FIGS. 9A-9D show a further embodiment of support clip 900 for a paint container. The support clip 900 is generally similar to the support clip 100 shown in FIGS. 1A-1E. The support clip 900 includes a flat member 920 including a container engagement section 910 comprising a plurality of edge surfaces. A brush holder support section 940 is configured for mounting a paint brush holder (not shown in this view) to the support clip and for supporting the paint brush holder, e.g., via pin and socket joint 950. Reference should be had to the description of support clip 100 for details of corresponding structures of support clip 900 including the container engagement section 910 and the brush holder support section 940. The support clip 900 includes a protuberance 960 that is configured to offset the support clip from a container inner sidewall surface in one of the orientations to mount the support clip 900 to a paint container. Reference should be had to the description of support clip 500 shown in FIGS. 5A-5B for details of the protuberance 960.

In various embodiments, the support clip 900 is a dual orientation support clip configured to mount the support clip to different types of paint container. The dual orientation support clip 900 includes a leg 930 extending from the flat member 920 adjacent the brush holder support section 940. The support clip defines a gap 934 between the leg 930 and the brush holder support section 940. The support clip 900 defines a round opening 938 at an interior end of the gap 934 between the leg 930 and the brush holder support section 940.

FIG. 9B shows a perspective view of the support clip 900. FIG. 9C shows an outward-facing side elevation view 970 of the support clip. FIG. 9D shows an inward-facing side elevation view 980 of the support clip. As shown in these views, the support clip 900 includes a thickness t alongside edge surfaces. By virtue of its thickness, the support clip 900 extends along an arc of a circumference or circular cross section of a container, such as a paint container in the form of a right circular cylinder. The leg 930 and the brush holder support section 940 may have arcuate surfaces facing the gap 934 configured to conform to inner and outer sidewall surfaces of a paint container in a first orientation of the support clip 900.

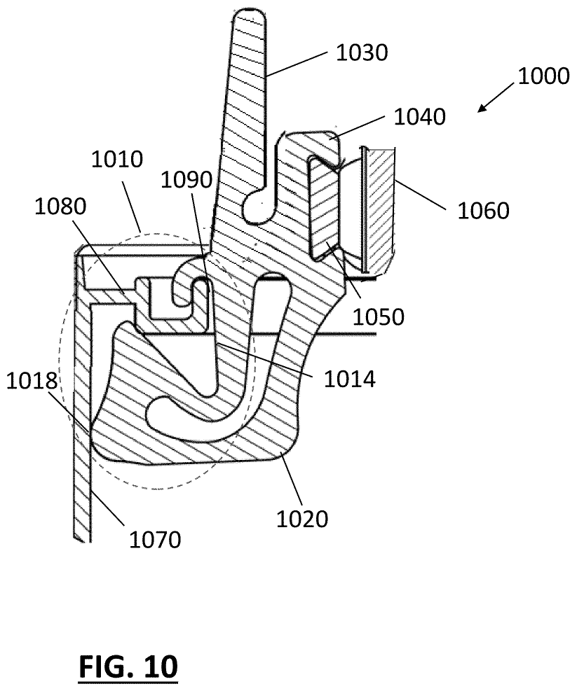

In various embodiments, the dual orientation support clip includes two orientations to mount the support clip to different types of paint container. The first orientation may be employed to mount the support clip to a paint container with rim. In the first orientation of support clip shown at 1000 in FIG. 10, the support clip is configured such that the plurality of edge surfaces of the container engagement section 1010 include a first segment 1014 configured to engage an inner edge 1090 of a rim 1080 including an annular member that extends inwardly adjacent an upper edge of a sidewall of a first paint container. The plurality of edge surfaces of the container engagement section include a second segment 1018 configured to engage an inner sidewall portion 1070 of the first paint container extending below the rim. The leg 1030 of the support clip extends above the paint container 1000 and does not engage the paint container in the first orientation.

The edge surfaces of the container engagement section 1010 may further include an intermediate segment extending between the first segment 1014 and the second segment 1018. The intermediate segment may be configured to engage a lower surface of the rim 1080. The first segment 1014 may include a hook configured to fit over an upper lip at the inner edge of the rim. The second segment 1018 may include a portion configured to engage an inner edge surface at the inner edge of the rim in the first orientation of the support clip. The second segment 1018 may include a protrusion configured to abut against the inner sidewall portion 1070 of the paint container with rim in order to adjust orientation of the support clip in the first orientation of the support clip. Reference should be had to the description of support clip 600 in FIG. 6D for additional details of corresponding structures of the support clip 1000.

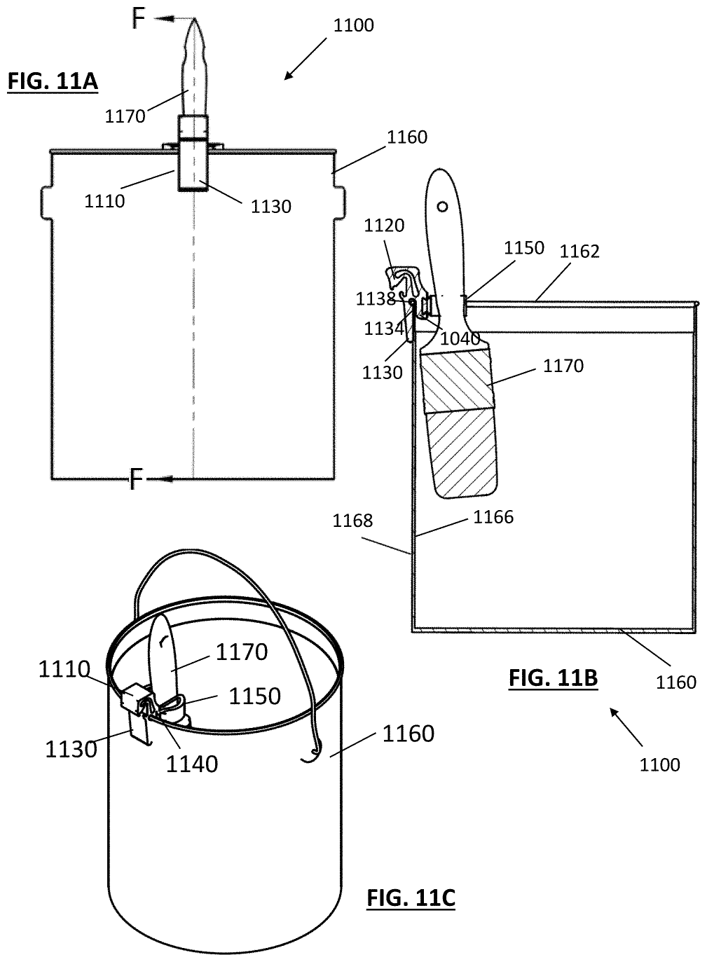

In a second orientation of support clip 1110 shown at 1100 in FIGS. 11A-11C, the support clip 1110 is configured to engage an inner sidewall surface 1166 and outer sidewall surface 1168 at an upper edge of a paint container 1160 without rim. The support clip 1110 extends vertically below the upper edge 1162 of the paint container 1160. In this orientation, the leg 1130 extends downwardly adjacent the outer sidewall surface 1168, and the brush holder support section 1140 extends downwardly adjacent the inner sidewall surface 1166. The support clip 1110 is configured to grip the outer sidewall surface and the inner sidewall surface of container 1160 at the gap 1134 between the leg 1130 and the brush holder support section 1140. A round opening 1138 at the interior end of the gap 1134 may be configured to fit over a bead at the upper edge 1162 of the paint container. The brush holder support section 1140 carries a brush holder 1150, which grips and supports a paint brush 1170 with its bristles extending vertically below the brush holder 1150. The container engagement section 1120 of the support clip 1110 extends above the paint container 1160 and does not engage the paint container in the second orientation.

The foregoing method descriptions and the interface configuration are provided merely as illustrative examples and are not intended to require or imply that the steps of the various embodiments must be performed in the order presented. As will be appreciated by one of skill in the art, the steps in the foregoing embodiments may be performed in any order. Words such as “then,” “next,” etc., are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

What is claimed is:

1. A paint container adapter, comprising:
a cylindrical outer rim and an inner ledge, wherein the outer rim and inner ledge define a lower section of the paint container adapter and an upper section of the paint container adapter,
wherein the lower section of the paint container adapter is configured to fit over a periphery of an open upper end of a lower paint container that faces upwardly, and the upper section of the paint container adapter is configured to fit under a periphery of an open end of an upper paint container that is inverted to face downwardly, and
wherein the paint container adapter, the lower paint container, and the upper paint container define an interior space configured to store a paint applicator, and the paint container adapter is configured to seal the periphery of the open upper end of the lower paint container and the periphery of the open end of the upper paint container to inhibit escape of any vapor within the interior space.

2. The paint container adapter of claim 1, wherein the paint container adapter comprises a circular cylindrical ring.

3. The paint container adapter of claim 1, wherein the paint container adapter comprises a circular cylindrical rim and an annular inner ledge.

4. The paint container adapter of claim 1, wherein the paint applicator comprises a paint brush, further comprising a brush holder configured to be mounted to upper interior portion of the lower paint container and configured to support the paint brush within the interior space.

5. The paint container adapter of claim 4, wherein the brush holder comprises a container engagement section comprising a plurality of edge surfaces configured for mounting the brush holder clip to the upper interior portion of the lower paint container.

6. The paint container adapter of claim 5, wherein the plurality of edge surfaces are configured for mounting the brush holder to an inner edge of an annular rim that extends inwardly from the periphery of the open upper end of the lower paint container and for mounting the brush holder to an inner sidewall surface of the lower paint container.

7. The paint container adapter of claim 5, wherein the brush holder further comprises a brush holder support section.

8. The paint container adapter of claim 4, wherein the brush holder is configured to support a handle of the paint brush with bristles of the paint brush suspended substantially vertically below the brush holder.

9. The paint container adapter of claim 1, wherein the paint applicator comprises a paint roller.

10. The paint container adapter of claim 1, wherein the lower section of the paint container adapter is configured to fit over a bead that extends around the periphery of the open upper end of the lower paint container, and the upper section of the paint container adapter is configured to fit under a bead that extends around the periphery of the open end of the upper paint container.

11. The paint container adapter of claim 1, wherein interior surfaces of the outer rim include bumps to aid retention of the lower container within the lower section and to aid retention of the upper container within the upper section.

12. A support clip, comprising:
a flat member including a container engagement section comprising a plurality of edge surfaces, a brush holder support section configured for mounting a paint brush holder to the support clip and for supporting the paint brush holder, and a leg extending from the flat member adjacent the brush holder support section and defining a gap between the leg and the brush holder support section,
wherein in a first orientation of the support clip, the support clip is configured such that the plurality of edge surfaces of the container engagement section comprise a first segment configured to engage an inner edge of a rim comprising an annular member that extends inwardly adjacent an upper edge of a sidewall of a first paint container and a second segment configured to engage an inner sidewall portion of the first paint container extending below the rim comprising the annular member extending inwardly adjacent the upper edge of a sidewall of the first paint container, and
wherein in a second orientation of the support clip, the support clip is configured such that the leg extends downwardly adjacent an outer sidewall surface of a second paint container at the upper edge of the second paint container and the brush holder support section extends downwardly adjacent an inner sidewall surface of the second paint container extending vertically below the upper edge of the second paint container, wherein the support clip is configured to grip the outer sidewall surface and the inner sidewall surface at the gap between the leg and the brush holder support section.

13. The support clip of claim 12, further comprising a paint brush holder mounted to the brush holder support section, wherein the paint brush holder is configured for holding a handle of a paint brush with bristles of the paint brush suspended substantially vertically below the paint brush holder.

14. The support clip of claim 13, wherein the paint brush holder is mounted to the brush holder support section via pin and socket joint.

15. The support clip of claim 12, wherein the plurality of edge surfaces of the first paint container engagement section further comprise an intermediate segment extending between the first segment and the second segment, wherein the intermediate segment is configured to engage a lower surface of the rim in the first orientation of the support clip.

16. The support clip of claim 15, wherein the first segment comprises a hook configured to fit over an upper lip at the inner edge of the rim, and the second segment further comprises a portion configured to engage an inner edge surface at the inner edge of the rim in the first orientation of the support clip.

17. The support clip of claim 12, wherein the second segment includes a protrusion configured to abut against the inner sidewall portion of the first paint container in order to adjust orientation of the support clip in the first orientation of the support clip.

18. The support clip of claim 12, wherein the support clip defines a round opening at an interior end of the gap between the leg and the brush holder support section, wherein the round opening is configured to fit over a bead at the upper edge of the second paint container in the second orientation of the support clip.

19. The support clip of claim 12, wherein in the first orientation of the support clip, the support clip is frictionally retained by the inner sidewall portion and the inner edge of the rim of the first paint container, and in the second orientation of the support clip, the support clip is frictionally engaged by the outer sidewall surface and the inner sidewall surface of the second paint container.

20. The support clip of claim 12, wherein in the second orientation of the support clip, the support clip is configured to engage a paint container without rim or a paint container from which a rim has been removed.
